(19) United States
(12) Patent Application Publication
(10) Pub. No.: US 2016/0042662 A1
(43) Pub. Date: Feb. 11, 2016

(54) System and Method of Learning the Chinese Written Language

(71) Applicant: Jon Lin, Rowland Heights, CA (US)

(72) Inventor: Jon Lin, Rowland Heights, CA (US)

(21) Appl. No.: 14/799,833

(22) Filed: Jul. 15, 2015

Related U.S. Application Data
(63) Continuation-in-part of application No. 13/646,270, filed on Oct. 5, 2012, now abandoned.
Application No. 13/646,270 is a continuation of application No. 14/594,147, filed on Jan. 11, 2015, now abandoned.

(51) Int. Cl. G09B 19/08

(52) U.S. Cl. CPC G09B 19/08

(57) ABSTRACT

A system and method for learning the Chinese language is disclosed. The system and method includes selecting and translating at least one character from the Chinese language into a different language. The characters of the translated word are then rearranged to resemble the Chinese character.

### REFERENCE TO PENDING APPLICATIONS

This application claims the benefit of U.S. patent application Ser. No. 13/646,270 filed on Oct. 5, 2012 and U.S. patent application Ser. No. 14/594,147 filed on Jan. 11, 2015.

### REFERENCE TO MICROFICHE APPENDIX

This application is not referenced in any microfiche appendix.

### BACKGROUND OF THE INVENTION

The present invention relates generally to the field of foreign languages and, in particular, to a novel system of learning the Chinese written language and a method for creating the same.

Written Chinese characters are used in many countries in Asia, Korea, Japan, the People's Republic of China, the Republic of China, Vietnam, Singapore, for example.

Increased interest in China from those outside has led to a corresponding increased interest in the study of Chinese as a foreign language. However the teaching of Chinese is one of the most difficult languages to learn for people, especially whose native language is one of the West Germanic languages, such as English and German, and the Romance languages, such as French, Italian and Spanish.

Difficulties with learning the Chinese language include the number of Chinese characters that must be learned, as compared to the few dozen symbols needed to write anything in the English language for example. Additionally, there is the manner in which the Chinese language is written.

Chinese sentences are written from top to down. Each Chinese character is created with a certain number of writing strokes. Generally speaking, it is traditional that each stroke begins sequentially from top to bottom and from left to right. By comparison, English language words are written from left to right. Sentences in the English language are written also from left to right. Moreover, the written Chinese language can be written according to five major styles, namely, Seal script (Small seal), Clerical script (Official script), Semi-cursive script (Running script), Cursive script (Grass script) and Regular script (Standard script).

Accordingly, it is an object of the present invention to provide a system of writing the Chinese written language and a method for creating the same.

### SUMMARY OF THE INVENTION

The inventive Chinese language and related method described herein satisfies the needs set out above.

An aspect of the present invention includes a method for writing the Chinese language including selecting and translating at least one character from the Chinese language into a different language. The resulting translated word will have at least one, but likely at least two characters from the different language. The characters from the different language are then arranged to resemble the character in the Chinese language. The different language utilized in this inventive method can be any known language, including the West Germanic languages, such as English and German, and the Romance languages, such as French, Italian and Spanish.

Upon reading the included description, various alternative embodiments will become obvious to those skilled in the art. These embodiments are to be considered within the scope and spirit of the subject invention, which is only limited by the claims which follow and their equivalents.

### BRIEF DESCRIPTION OF THE DRAWINGS

FIG. 1 is a block diagram of an embodiment of the method of the present invention.

FIG. 2A is a depiction of a traditional Chinese character in regular script for the word “salt”.

FIG. 2B is a depiction of the traditional Chinese character in semi-grass script for the word “salt” as shown in FIG. 2A utilizing an embodiment of the method of the present invention.

FIG. 3A is a depiction of a traditional Chinese character in regular script for the word “holiday”.

FIG. 3B is a depiction of the traditional Chinese character in semi-grass script for the word “holiday” as shown in FIG. 3A utilizing an embodiment of the method of the present invention.

FIG. 4A is a depiction of a traditional Chinese character in regular script for the word “peace”.

FIG. 4B is a depiction of the traditional Chinese character in semi-grass script for the word “peace” as shown in FIG. 4A utilizing an embodiment of the method of the present invention.

FIG. 5A is a depiction of a traditional Chinese character for the word “dragon”.

FIG. 5B is a depiction of the traditional Chinese character in semi-grass script for the word “dragon” as shown in FIG. 5A utilizing an embodiment of the method of the present invention.

FIG. 6A is a depiction of a traditional Chinese character for the word “dream”.

FIG. 6B is a depiction of the traditional Chinese character in semi-grass script for the word “dream” as shown in FIG. 6A utilizing an embodiment of the method of the present invention.

FIG. 7A is a depiction of a traditional Chinese character for the word “smart”.

FIG. 7B is a depiction of the traditional Chinese character for the word “smart” as shown in FIG. 7A utilizing an embodiment of the method of the present invention.

FIG. 8A is a second depiction of a traditional Chinese character for the word “smart”.

FIG. 8B is a depiction of the traditional Chinese character for the word “smart” as shown in FIG. 8A utilizing an embodiment of the method of the present invention.

FIG. 9 is a block diagram of an embodiment of the system of the present invention.

### DESCRIPTION OF THE PREFERRED EMBODIMENTS

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

In China's 5,000 years or so of history, they have not encountered the alphabet of the modern languages, such as English, until the last few hundred years. Additionally, out of the current 7 or so billion people on the planet, it has been estimated that there are about 1.2 billion Chinese speakers and 1.5 billion English speakers.

Currently, there are several scripts for writing Chinese characters, e.g. the clerical script, the seal script, the semi-cursive script. To aid in understanding the Chinese characters, the People's of Republic of China has recently begun to simplify those characters. To date, some 8,000 Chinese characters have been simplified in People's Republic of Chinese

The present invention provides for a novel way of writing Chinese characters. In general, it uses the alphabet letters from a first language, not Chinese, that make up the translation of the Chinese character under consideration to write that Chinese character.

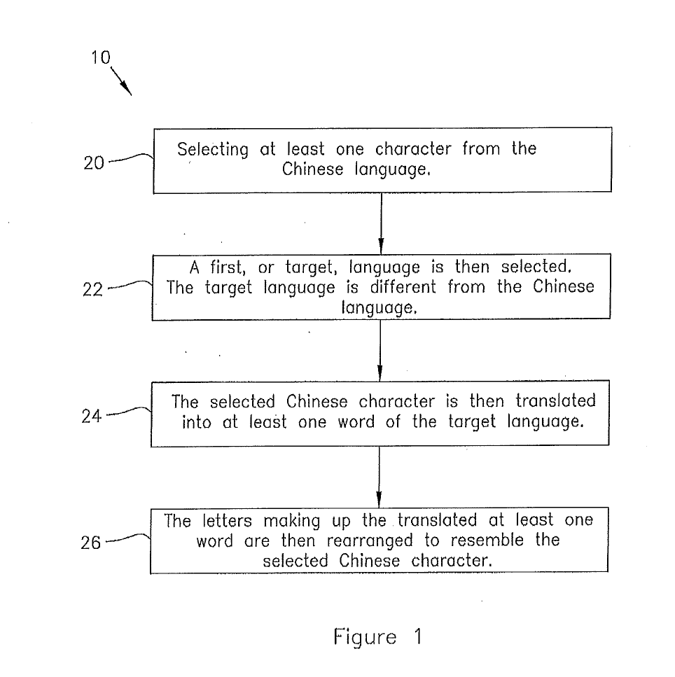

As shown by FIG. 1, an embodiment 10 of the inventive method illustrates the steps that include selecting at least one character from the Chinese language at step 20. A first, or target, language is then selected at step 22. The target language is different from the Chinese language. The selected Chinese character is then translated into at least one word of the target language at step 24. The letters making up the translated at least one word is then rearranged to resemble the selected Chinese character at step 26. The target language in illustrated to be English, but those skilled in the art would recognize that the use of English is for illustration and that other languages can be utilized.

### EXAMPLES

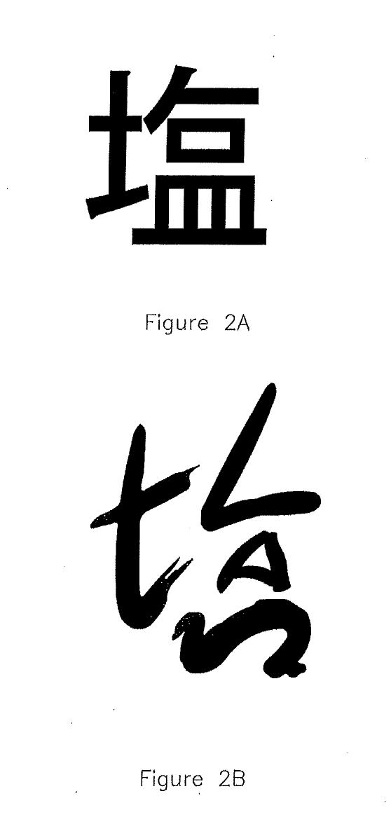

One example of the inventive method is illustrated with the English word “Salt”. FIG. 2A shows the Chinese character for “salt.” FIG. 2B is the Chinese character for “salt” that has been rewritten using the letters s, a, l and t. This example illustrates how the translated word utilizes capital and lower case letters to establish a similar character to the Chinese character.

Further, the letters are arranged to follow the writing strokes in Chinese. It can be and is still recognizable, when explained to the reader, if the letters are arranged in the reverse order. The less they are out of order, the less they do not appear random, the easier it is to read. In this example, the Chinese character is written using the following sequence, t L A S and not S A L t.

The use of capital and lower case letters is illustrative. Other forms of translation can also be employed. These other forms include the utilization of cursive script, block letters, abbreviations (e.g. sm for small), scientific/technical symbols (e.g. H2O for water) and Arabic numbers (e.g. 100 for hundred), in order to create a Chinese character using the same letters of the English word. Additionally, punctuation marks, for example the question mark, ‘?’, and mirror images can be utilized. Further, the English letter ‘o’, which is a hollow circle, can be modified to resemble a solid stroke or dot in the Chinese character, as in the example of [symbol] ; the ‘o’ in its English translation (dragon) corresponds to a short, solid horizontal stroke in Chinese (here, it is the stroke ‘-’ (like the hyphen mark) in the upper right hand corner of [symbol] ).

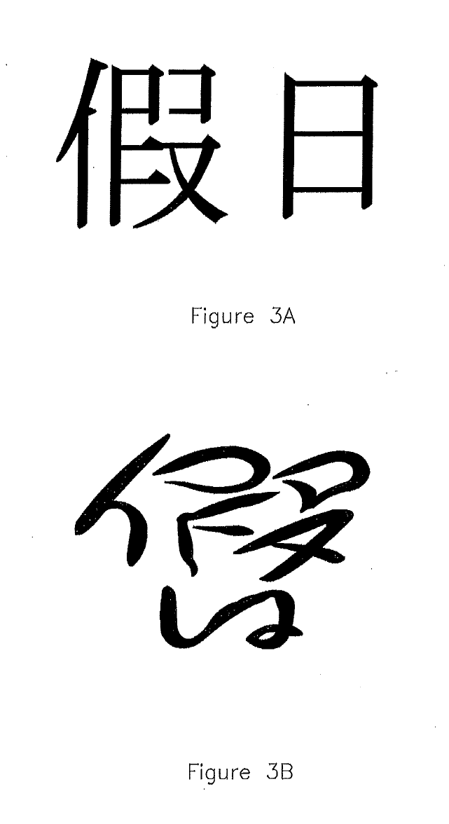

An additional example of the inventive method is illustrated with the English word “Holiday”. FIG. 3A shows the Chinese characters for “holiday.” FIG. 3B is the Chinese character for “holiday” that has been rewritten using the letters h, o, l, i, d, a, and y.

In this example, there are two Chinese characters but are translated into a single English word. To obtain the stroke order for writing the Chinese character, the English letters that are utilized include h, o, L, I, D, A and y.

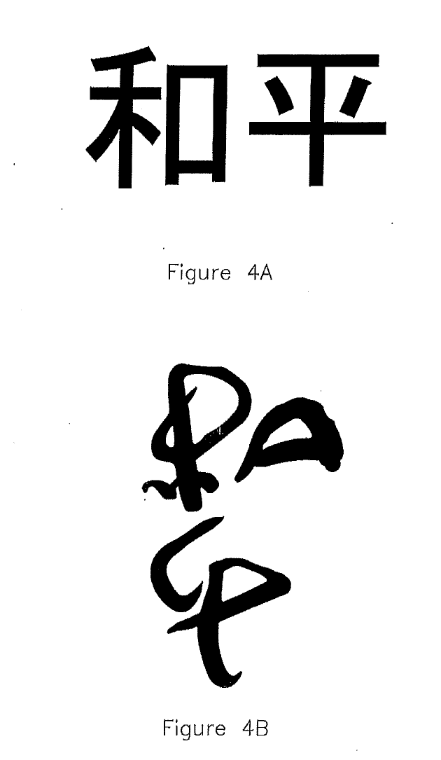

An additional example of the inventive method is illustrated with the English word “Peace”. FIG. 4A shows the Chinese character for “Peace.” FIG. 4B is the Chinese character for “Peace” that has been rewritten using the letters p, E, A, c and e.

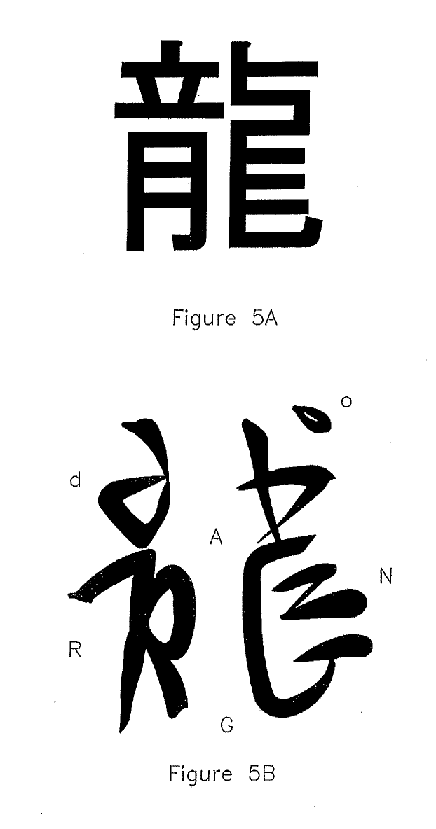

An additional example of the inventive method is illustrated with the English word “Dragon”. FIG. 5A shows the Chinese character for “Dragon.” FIG. 5B is the Chinese character for “Dragon” that has been rewritten using the letters d, R, A, G, o, and N. This example illustrates the English characters follow the correct sequence of the Chinese writing strokes.

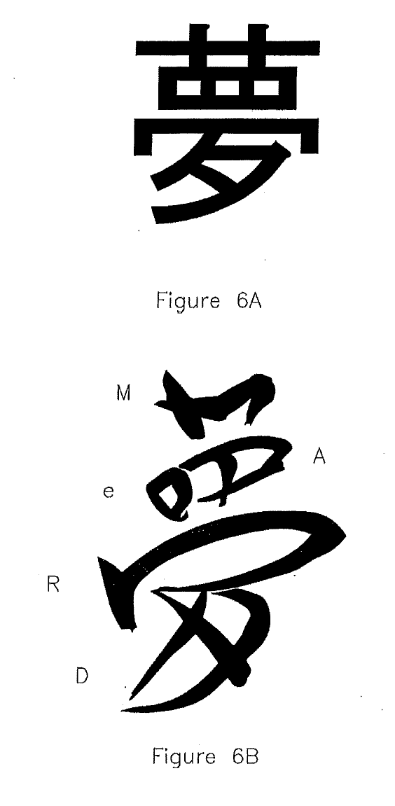

An additional example of the inventive method is illustrated with the English word “Dream”. FIG. 6A shows the Chinese character for “Dream.” FIG. 6B is the Chinese character for “Dream” that has been rewritten using the letters D, R, e, A, and M. This example illustrates that at times it is necessary to change the orientation of the English letter. Here, the “A” is turned on its side and the English characters follow the reverse sequence of the Chinese writing strokes, i.e. M, A, e, R, and D. Additionally, FIG. 6B shows the English character positioned next to the rewritten Chinese character.

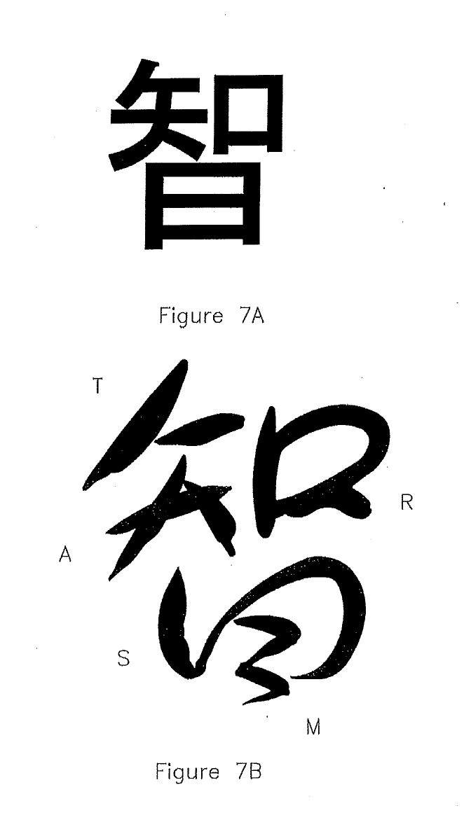

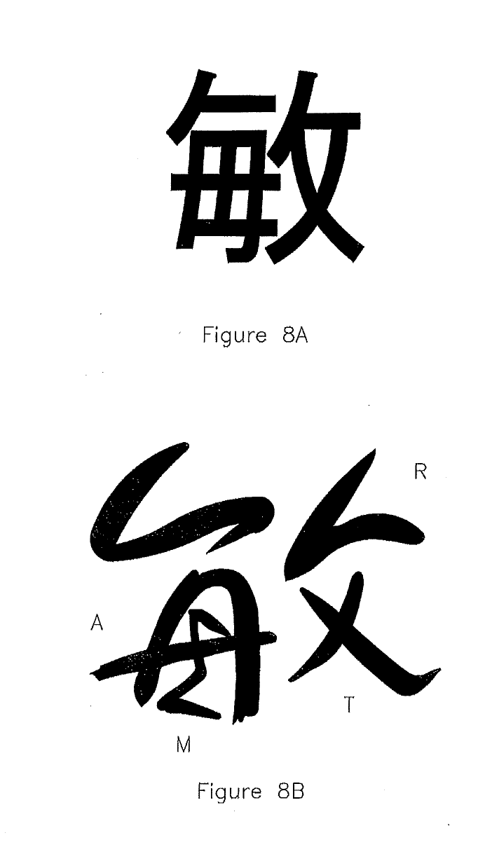

An additional example of the inventive method is illustrated with the English word “Smart”. FIGS. 7A and 8A shows two different Chinese characters for “Smart.” FIGS. 7B and 8B are the Chinese character for “Smart”. This example illustrates how even synonyms in Chinese can be made to correspond to the same English word.

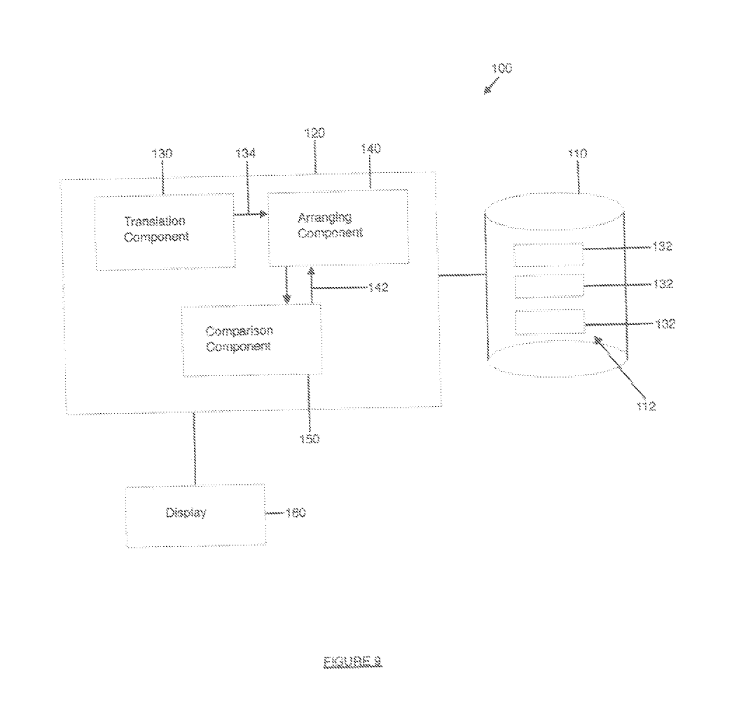

As shown by FIG. 9, an embodiment 100 of the inventive system is shown. Embodiment 100 includes a database 110 of a plurality of Chinese language characters 112 and a computer 120. Computer 120 is coupled to database 110.

A translation component 130 is located within computer 120 and translates at least one character 132 from said plurality of Chinese language characters 112 into at least one word having at least two characters of a target language 134. The target language is different from the Chinese language. In this embodiment, the target language is English, however, this is illustrative and not meant to be limiting.

An arranging component 140 is located within computer 120 and arranges the characters of the target language word 134 to resemble the translated Chinese language character 132 resulting in an arranged target language word 142

A comparison component 150 is located within computer 120 and compares the arranged target language word 142 with translated Chinese language character 132 to determine the visual accuracy of arranged target language word 142 as compared to the translated Chinese language character 132. If the accuracy is below a predetermined level of accuracy, the arranged target language word 142 is rearranged and compared until the accuracy of the rearranged at least one character from the Chinese language satisfies the predetermined level of accuracy.

A display component 160 is connected to computer 120. Display component is capable of displaying the translated Chinese language character 132, the target language word 134 and the arranged target language word 142. A person who has an understanding of the target language but not the Chinese language is able to visually look upon the translated Chinese language character 132 and arranged target language word 142 which allows the person to gain an understanding for the meaning of the Chinese language character.

Advantages of the present invention range from personal to corporate. Regarding the personal advantages, if common ground can be found between two written languages as distinct in form, construction and developmental history as Chinese and English, there will be better communication and better relations.

Regarding the corporate advantages, a corporation that is interested in Chinese and/or English markets will find tremendous appeal in the ability to cut through the language barrier by the application of the present invention.

While embodiments of the present invention have been illustrated and described, such disclosures should not be regarded as any limitation of the scope of our invention. The true scope of our invention is defined in the appended claims. Therefore, it is intended that the appended claims shall be construed to include both the preferred embodiment and all such variations and modifications as fall within the spirit and scope of the invention.

We claim:

1. A system to simulate the Chinese language, the system comprising:
a database of a plurality of Chinese language characters;
a computer, coupled to said database, that is configured to
(a) translate at least one character from said plurality of Chinese language characters into at least one word of a target language, said target language being different than the Chinese language, the translated at least one word having at least two target language characters;
(b) arranging the at least two target language characters to resemble the at least one character from the Chinese language;
(c) compare the arranged at least two target language characters with the at least one character from the Chinese language to determine the accuracy of arranged at least one target language character; and
(d) if the accuracy is below a predetermined level of accuracy, rearrange and compare the arranged at least two target language characters until the accuracy of the rearranged at least one character from the Chinese language satisfies the predetermined level of accuracy.

2. The system of claim 1, wherein the target language is the English language.

3. The system of claim 1, wherein the target language is the German language.

4. The system of claim 1, wherein the target language is the French language.

5. The system of claim 1, wherein the at least two target language characters are capital letters.

6. The system of claim 1, wherein the at least two target language characters are lower case letters.

7. The system of claim 1, wherein the at least two target language characters are a combination of capital letters and lower case letters.

8. The system of claim 1, wherein at least one character from the Chinese language is written following a forward stroke order and wherein the at least two target language characters are written following the forward stroke order.

9. The system of claim 1, wherein at least one character from the Chinese language is written following a reverse stroke order and wherein the at least two target language characters are written following the reverse stroke order.

10. The system of claim 1, wherein at least one of the at least two target language characters is abbreviated.

11. The system of claim 1, wherein at least one of the at least two target language characters is represented by scientific or technical symbols

12. The system of claim 1, wherein at least one of the at least two target language characters is represented by Arabic numbers

13. The system of claim 1, wherein at least one of the at least two target language characters is represented by at least one punctuation mark.

14. A method for learning the Chinese language comprising the steps of:
selecting at least one character from the Chinese language;
selecting a target language, the target language being different from the Chinese language;
translating the at least one character from the Chinese language into the target language, the translated at least one character from the Chinese language having at least one word of the target language, the translated at least one word having at least one target language character; and
arranging the at least one target language character to approximately resemble the at least one character from the Chinese language so that when the arranged at least one target language character is viewed by a reader having an understanding of the target language, the reader is capable of learning the meaning of the at least one character from the Chinese language.

15. The method of claim 14, wherein the target language is the English language.

16. The method of claim 14, wherein the at least one target language character is defined as having at least two target language characters.

17. The method of claim 16, wherein at least one character from the Chinese language is written following a forward stroke order and wherein the at least two target language characters are written following the forward stroke order.

18. The method of claim 16, wherein at least one character from the Chinese language is written following a reverse stroke order and wherein the at least two target language characters are written following the reverse stroke order.
